(19) United States
(12) Patent Application Publication
(10) Pub. No.: US 2020/0274939 A1
(43) Pub. Date: Aug. 27, 2020

(54) OPTIMIZED TELEMETRY-GENERATED APPLICATION-EXECUTION POLICIES BASED ON INTERACTION DATA

(71) Applicant: Microsoft Technology Licensing, LLC, Redmond, WA (US)

(72) Inventors: Md. Nazmus SAKIB, Seattle, WA (US); Isha Aniruddha OKE, Bellevue, WA (US); Scott Randall SHELL, Kirkland, WA (US); Jeffrey Alan SUTHERLAND, Seattle, WA (US); Jaskaran Singh KHURANA, Bellevue, WA (US); Thomas Walter CALDWELL, III, Bellevue, WA (US); Zhouheng SUN, Los Angeles, CA (US); Noah McGregor HARPER, Cartersville, GA (US)

(21) Appl. No.: 16/286,299

(22) Filed: Feb. 26, 2019

(51) Int. Cl. H04L 29/08; G06F 11/34

(52) U.S. Cl. CPC H04L 67/22; H04L 67/125; H04L 67/306; G06F 11/3419; H04L 67/2852; G06F 11/3438

(57) ABSTRACT

The present disclosure concerns systems and methods for generating application-control policies. A system may receive application-usage data for a set of devices. The application-usage data may identify binaries with which a user interacted. The system may determine one or more application-usage characteristics for one or more devices in the set of devices based at least in part on the application-usage data and may rely solely on data associated with the binaries with which the user interacted. The system may identify a set of candidate devices based on the one or more application-usage characteristics. The application-usage characteristics may include a measure of distinct applications used during a specified time period and a measure of variability of application usage across a set of specified time periods. The system may generate an application-control policy for the set of candidate devices based on application-usage data for the set of candidate devices.

### CROSS-REFERENCE TO RELATED APPLICATIONS

N/A

### BACKGROUND

There are many different types of computing devices in use today, including desktop computers, laptop computers, tablet computers, smartphones, virtual reality headsets, wearable computing technology, and the like. Computing devices may be used to perform a wide variety of tasks, such as accessing websites via the Internet, using word processing software to create documents, playing video games, composing and sending email and/or text messages, watching videos, listening to music, and so forth.

Computing devices may use a variety of software applications to perform tasks. For example, a user of a computing device may use an internet browser application to access information on the internet and then use a presentation application to create a presentation communicating information obtained from the internet. Software applications may include a number of different files and may create additional files during execution.

Computer malware may be a computer file intended to harm a computing device or obtain information from the computing device. One strategy for stopping computer malware from being executed on a computing device is through use of an application-control policy. An application-control policy may restrict the software applications and files that can be executed on a computing device. Application-control policies can be time consuming to create and maintain. Security personnel may need to carefully analyze internal application requirements. The quantity of applications used or approved by organizations can quickly climb into the thousands and the process of recording the executables that make the whitelist can become a substantial research problem. Solving that research problem may also require extensive coordination between information technology (IT) administrators and enterprise employees familiar with the executables required for day-to-day productivity.

### SUMMARY

A system for generating an application-control policy for deployment on one or more devices is disclosed. The system may include one or more processors and memory comprising instructions that are executable by the one or more processors to perform certain operations. The operations may include receiving a first set of application-usage data for a set of devices. The operations may include determining one or more application-usage characteristics for one or more devices in the set of devices based at least in part on the first set of application-usage data. The operations may include identifying a set of candidate devices from the set of devices based at least in part on the one or more application-usage characteristics. The operations may include generating the application-control policy for the set of candidate devices based on a second set of application-usage data for the set of candidate devices. The operations may also include providing the application-control policy for deployment on the set of candidate devices.

The first set of application-usage data may identify binaries with which users of the set of devices interacted. Determining the one or more application-usage characteristics for the one or more devices in the set of devices may be done based on data associated with the binaries with which users of the one or more devices interacted.

The one or more application-usage characteristics may include a measure of distinct applications used during a specified time period. Identifying the set of candidate devices may include determining that a device from the set of devices whose measure of distinct applications used during the specified time period does not meet a defined criteria is not part of the set of candidate devices. The measure of distinct applications used during the specified time period may be a number of distinct applications used during the specified time period.

The one or more application-usage characteristics may include a measure of variability of application usage across a set of specified time periods. Identifying the set of candidate devices may include determining that a device from the set of devices whose measure of variability of application usage across the set of specified time periods does not meet a defined criteria is not part of the set of candidate devices. The measure of variability of application usage may be determined by dividing a first number of applications used only during a first specified time period by a second number of applications used across each time period of the set of specified time periods, the first specified time period being in the set of specified time periods.

The second set of application-usage data for the set of candidate devices may cover a time period not identical to the first set of application-usage data for the set of devices.

The operations may further include deploying the application-control policy to the set of candidate devices.

A computer-implemented method is disclosed. The method may include receiving a first set of application-usage data for a set of devices, determining one or more application-usage characteristics for one or more devices in the set of devices based at least in part on the first set of application-usage data, identifying a set of candidate devices from the set of devices based at least in part on the one or more application-usage characteristics, generating an application-control policy for the set of candidate devices based on a second set of application-usage data for the set of candidate devices, and providing the application-control policy for deployment on the set of candidate devices.

The first set of application-usage data may include interaction data. Determining the one or more application-usage characteristics for the one or more devices in the set of devices may be done based on interaction data.

The one or more application-usage characteristics may include a measure of distinct applications used during a specified time period. Identifying the set of candidate devices may include determining that a device from the set of devices whose measure of distinct applications used during the specified time period does not meet a defined criteria is not part of the set of candidate devices.

The one or more application-usage characteristics may include a measure of variability of application usage across a set of specified time periods. Identifying the set of candidate devices may include determining that a device from the set of devices whose measure of variability of application usage across the set of specified time periods does not meet a defined criteria is not part of the set of candidate devices.

A computer-readable medium is also disclosed. The computer-readable medium may include computer-executable instructions that, when executed, cause one or more processors to perform certain operations. The operations may include receiving a first set of application-usage data for a set of devices and determining one or more application-usage characteristics for one or more devices in the set of devices based at least in part on the first set of application-usage data. The one or more application-usage characteristics may include a measure of distinct applications used during a specified time period. The one or more application-usage characteristics may also include a measure of variability of application usage across a set of specified time periods. The operations may include identifying a set of candidate devices from the set of devices based at least in part on the one or more application-usage characteristics. Identifying the set of candidate devices may include determining that a first device from the set of devices whose measure of distinct applications used during the specified time period does not meet a first criteria is not part of the set of candidate devices. Identifying the set of candidate devices may also include determining that a second device from the set of devices whose measure of variability of application usage across the set of specified time periods does not meet a second criteria is not part of the set of candidate devices. The operations may include generating an application-control policy for the set of candidate devices based on a second set of application-usage data for the set of candidate devices. The operations may also include providing the application-control policy for deployment on the set of candidate devices.

The first set of application-usage data may identify binaries with which users of the set of devices interacted. Determining the one or more application-usage characteristics for the one or more devices in the set of devices may be done based on data associated with the binaries with which users of the one or more devices interacted.

### BRIEF DESCRIPTION OF THE DRAWINGS

In order to describe the manner in which features of the disclosure can be obtained, a description will be rendered by reference to specific embodiments thereof which are illustrated in the appended drawings. For better understanding, similar reference numbers have been used for similar features in the various embodiments. Unless indicated otherwise, these similar features may have the same or similar attributes and serve the same or similar functions. Understanding that the drawings depict some examples of embodiments, the embodiments will be described and explained through the use of the accompanying drawings in which:

FIG. 1 illustrates one example of an application-control system that includes an enterprise and a policy-generation unit.

FIG. 2 illustrates one example of a policy-generation unit that may be used to receive data, identify a set of candidate devices, and generate an application-control policy.

FIG. 3 illustrates one example of an enterprise that may form part of an application-control system.

FIG. 4 illustrates one example of a device that may form part of an enterprise.

FIG. 5 illustrates an example method that may be used to generate and deploy an application-control policy to a set of candidate devices.

FIG. 6 illustrates an example method that may be used to revise an application-control policy.

FIG. 7 illustrates certain components that may be included within a computer system.

### DETAILED DESCRIPTION

Applying an application-control policy (such as a policy that restricts execution of any unapproved applications or binaries) to computing devices can help add security to high-risk environments, including large enterprises that utilize thousands of computing devices. Unfortunately, manually creating an application-control policy can be a lengthy and time-consuming process for enterprise IT and security professionals. It may present a substantial research problem that becomes worse as an organization grows. Monitoring and editing policies to account for application updates adds another layer of manageability.

Creating a list of approved applications for an application-control policy whitelist may require that IT and security personnel analyze enterprise devices and individually approve or disapprove applications. It may also require that IT or security administrators coordinate with enterprise employees familiar with the applications necessary for day-to-day productivity. Even after these personnel complete their initial research, they may need to maintain the policy as whitelisted applications age and are updated. In addition to monitoring updates, the onboarding of new applications post-policy generation may need to be individually communicated to the IT or security team for whitelisting purposes.

The present disclosure relates to systems and methods for creating and updating application-control policies using application-telemetry data. The disclosed systems and methods generate application-control policy recommendations in an automated way based on current application usage of devices associated with an organization. One way the disclosed systems and methods may generate an application-control policy is to use application-usage data associated with a group of devices to identify a sub-group of devices and then generate an application-control policy for the sub-group of devices. Application-usage data may be data or information regarding application and binary executions that occur on a device. Application-usage data may include information associated with an application or binary execution, such as a name and file type of the application or binary and a time and date an execution occurred.

The sub-group of devices may be a set of devices whose application-usage data suggests that a single application-control policy can add sufficient security to the devices while imposing a sufficiently low potential for productivity interference. The disclosed systems and methods may use various means and criteria to identify a sub-group of devices. The disclosed systems and methods may identify a sub-group of devices by identifying devices that have one or more similarities in application usage or have application usage that meets one or more defined criteria. For example, the disclosed systems and methods may identify as a sub-group of devices a set of devices that each (1) used a sufficiently similar number of applications during a specific time period and (2) used a sufficiently consistent set of applications across two or more specific time periods.

In identifying a sub-group of devices, the disclosed systems and methods may rely only on application-usage data for binaries with which a user of a device interacted (as opposed to all binaries executed by a device). Relying only on application-usage data associated with binaries with which a user of a device interacted may optimize identifying sub-groups of devices because the amount of application-usage data associated with binaries with which a user interacted may be significantly smaller in size that application-usage data associated with all binaries executed on a device.

After identifying a sub-group of devices, the disclosed systems and methods may generate an application-control policy based on application-usage data associated with devices in the sub-group of devices. That application-control policy may then be deployed to the sub-group of devices or provided for deployment to the sub-group of devices. The application-control policy may be modified by enterprise IT personnel. The disclosed systems and methods also may be used to further refine the deployed application-control policy.

The disclosed systems and methods may generate application-control policies tailored to specific business requirements without significant investment of time and resources by IT and enterprise personnel. As a result, the present disclosure helps relieve burdens on IT professionals who want the security of an application-control policy but are unable to develop and maintain accurate policies. The present disclosure also simplifies initial policy research and management and relieves policy management frustration and complexity by reducing the length of the application whitelisting process.

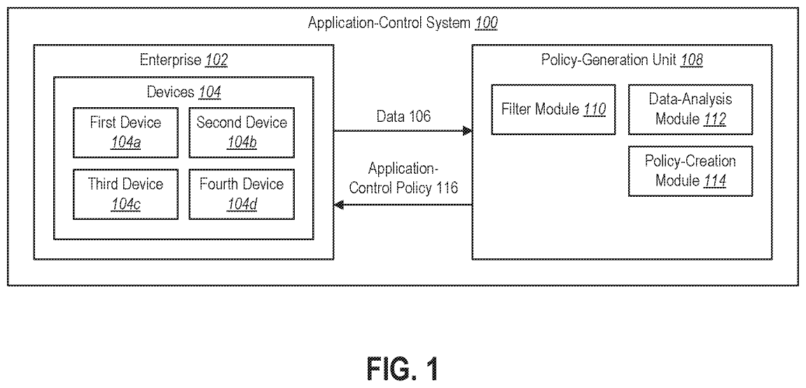

FIG. 1 illustrates a potential example of an application-control system 100 that could be used to generate an application-control policy 116. The application-control policy 116 may include a list of approved applications and/or binaries that a device can execute and may prohibit the device from executing any unapproved applications and/or binaries. The application-control system 100 may include an enterprise 102 and a policy-generation unit 108.

The enterprise 102 may be an individual or organization that uses at least one computing device. The enterprise 102 may include a set of devices 104 that may be used to perform tasks for the enterprise 102. Each device 104a, 104b, 104c, 104d in the set of devices 104 may have an associated user. The associated user for each device 104a, 104b, 104c, 104d may use one or more applications to perform tasks for the enterprise 102. A user of a device may attempt, intentionally or unintentionally, to use applications or execute binaries that are unwanted or malicious.

The set of devices 104 may produce application-usage data. Application-usage data may include information regarding binary executions (execution events) that occur on the set of devices 104. In some instances, a sub-type of execution event may be an interaction event. An interaction event may be an execution event that results from a user interacting with a device. An example of a binary execution resulting from user interaction may be a user starting an internet browser application by double-clicking on an application icon on a laptop computer's screen. The icon may cause the laptop computer to execute a program file (such as internetbrowser.exe). The execution of internetbrowser.exe may be an interaction event. Once internetbrowser.exe is running, it may cause the laptop computer to execute other binaries. Execution of those binaries may be execution events but may not be interaction events.

In some cases, the set of devices 104 may produce data regarding interaction events as a distinct data stream. Thus, application-usage data may include interaction data (containing information regarding interaction events) as a data stream distinct from execution data (containing information regarding execution events). In other cases, application-usage data may indicate, directly or indirectly, what execution events are interaction events.

The policy-generation unit 108 may be designed to receive data 106 (which may include application-usage data) from the enterprise 102. The policy-generation unit 108 may use application-usage data to identify one or more sub-groups of devices within the set of devices 104, and, for each identified sub-group of devices, use application-usage data to generate the application-control policy 116. The policy-generation unit 108 may identify a sub-group of devices based in part on application-usage characteristics of one or more devices within the set of devices 104.

An application-usage characteristic of a device may be any way of characterizing, describing, or measuring application usage of the device or an aspect of application usage of the device. An application-usage characteristic of a device may be a quantifiable metric of application usage of the device or an aspect of application usage of the device. An application-usage characteristic of a device may be determined for a specific time period or across two or more time periods. Application-usage characteristics may include how many different applications a device uses, how consistently a device uses a same set of applications, how frequently a device uses a new application, how long a device uses an application, how often a device uses an application, how many binary executions occurred on a device, or how many unwanted binaries a device attempted to execute. Application-usage characteristics of a device may be determined based on application-usage data associated with the device. An application-usage characteristic of a device may be relative to application-usage characteristics of other devices.

In identifying a sub-group of devices (which may also be referred to as a set of candidate devices), the policy-generation unit 108 may seek to identify one or more devices for which a single application-control policy may provide a sufficient level of security without interfering with appropriate and desirable use of the one or more devices. A set of candidate devices may be one or more devices for which a single application-control policy adequately balances security and productivity interests of the enterprise 102. A set of candidate devices may be one or more devices whose application-usage characteristics are sufficiently similar. A set of candidate devices may be one or more devices whose application-usage characteristics satisfy one or more defined criteria.

To generate the application-control policy 116 for a set of candidate devices the policy-generation unit 108 may utilize one or more of a filter module 110, a data-analysis module 112, and a policy-creation module 114.

The filter module 110 may be designed to reduce an amount of application-usage data used by the policy-generation unit 108 to identify a set of candidate devices or to generate an application-control policy for a set of candidate devices. The filter module 110 may filter application-usage data such that the policy-generation unit 108 relies solely on interaction data to identify a set of candidate devices. The filter module 110 may also filter application-usage data such that the policy-generation unit 108 does not consider known malicious or unwanted binaries in generating an application-control policy.

The data-analysis module 112 may be designed to identify a set of candidate devices. The data-analysis module 112 may identify a set of candidate devices based at least in part on application-usage data (which may have been filtered by the filter module 110). The data-analysis module 112 may identify a set of candidate devices based solely on interaction data. Relying solely on interaction data may allow the data-analysis module 112 to identify a set of candidate devices more efficiently and faster than would be possible relying on all execution data. It may be more efficient to rely on interaction data because it may be that there are far more total execution events than interaction events for the same time period(s).

The data-analysis module 112 may identify a set of candidate devices based at least in part on the set of candidate devices having certain similarities in application usage. The data-analysis module 112 may identify a set of candidate devices based at least in part on each device within the set of candidate devices meeting certain criteria, including criteria related to application usage. The data-analysis module 112 may use a variety of measurements, calculations, and metrics to identify a set of candidate devices.

Two example measurements the data-analysis module 112 may use to identify a set of candidate devices are distinct application usage and application-usage variability.

In identifying a set of candidate devices, the data-analysis module 112 may measure how many distinct applications a user of a device interacted with during one or more time periods (distinct application usage). Measuring how many distinct applications a user of a device interacted with may help identify a set of candidate devices because it may be that a single application-control policy is more likely to be effective for a set of devices that have interacted with a similar number of applications during a particular time period.

In identifying a set of candidate devices, the data-analysis module 112 may also be designed to use a measure of variability of application usage by a device across two or more time periods (application-usage variability). Measuring application-usage variability may help identify a set of candidate devices because it may be that an application-control policy may excessively interfere with productivity when applied to devices that need to frequently utilize new applications.

The data-analysis module 112 may identify a set of candidate devices based at least in part on distinct application usage and application-usage variability of one or more devices of the set of devices 104 associated with the enterprise 102. For example, the data-analysis module 112 may group together as a set of candidate devices those devices whose distinct application usage falls within a specified range and whose application-usage variability falls within a specified variability range.

By way of example, assume the data-analysis module 112 shown in FIG. 1 is designed to identify as a set of candidate devices those devices that have distinct application usage of less than 20 and have low application-usage variability. Assume for purposes of this example that distinct application usage is determined based on a raw count of the number of distinct applications a user of a device interacted with during a particular time period. For purposes of this example, assume that the data-analysis module determines that (1) a first user of the first device 104a interacted with 10 applications during a particular day and had high application-usage variability across a particular week, (2) a second user of the second device 104b interacted with 80 applications during the particular day and had low application-usage variability across the particular week, (3) a third user of the third device 104c interacted with 8 applications during the particular day and had low application-usage variability across the particular week, and (4) a fourth user of the fourth device 104d interacted with 9 applications during the particular day and had low application-usage variability across the particular week.

Based on these example assumptions, the data-analysis module 112 may determine that the first device 104a, the third device 104c, and the fourth device 104d could potentially be a set of candidate devices because the first device 104a, the third device 104c, and the fourth device 104d each have distinct application usage that is less than 20. The data-analysis module 112 may determine, based on application-usage variability measurements, that the second device 104b, the third device 104c, and the fourth device 104d could potentially be a set of candidate devices because each has low application-usage variability. The data-analysis module 112 may identify the third device 104c and the fourth device 104d as a set of candidate devices because both devices have distinct application usage that is less than 20 and low application-usage variability. In this example, the data-analysis module 112 analyzed distinct application usage and application-usage variability of all devices in the set of devices 104. In other examples, the data-analysis module 112 may perform a first type of measurement and then perform a second type of measure on only those devices that may potentially be included in a set of candidate devices based on results from performing the first type of measurement.

After the data-analysis module 112 identifies a set of candidate devices, the policy-creation module 114 may generate the application-control policy 116 for the set of candidate devices based at least in part on application-usage data associated with the set of candidate devices. Application-usage data used to generate the application-control policy 116 may not be identical to application-usage data used to identify a set of candidate devices. For example, the data-analysis module 112 may use only interaction data to identify a set of candidate devices while the policy-creation module 114 may use execution data (which may also include information regarding interaction events) to generate the application-control policy 116. One other example of how the data-analysis module 112 and the policy-creation module 114 may not use identical application-usage data is that the data-analysis module 112 may use application-usage data from a first time period while the policy-creation module 114 may use application-usage data from a second time period (not identical to the first time period) to generate an application-control policy.

The policy-generation unit 108 may be designed to provide the application-control policy for deployment to a set of candidate devices or deploy the application-control policy 116 to a set of candidate devices. The policy-generation unit 108 may deploy the application-control policy 116 directly to a set of candidate devices or may send an application-control policy to the enterprise 102. The enterprise 102 may modify the application-control policy 116.

Some or all of the policy-generation unit 108 may be located at a location separate from the enterprise 102. For example, the policy-generation unit 108 may be located in a cloud computing system. In other designs, some or all of the policy-generation unit 108 may be located at a same location as the enterprise 102. For example, the policy-generation unit 108 may be located on a hardware server maintained at the enterprise 102.

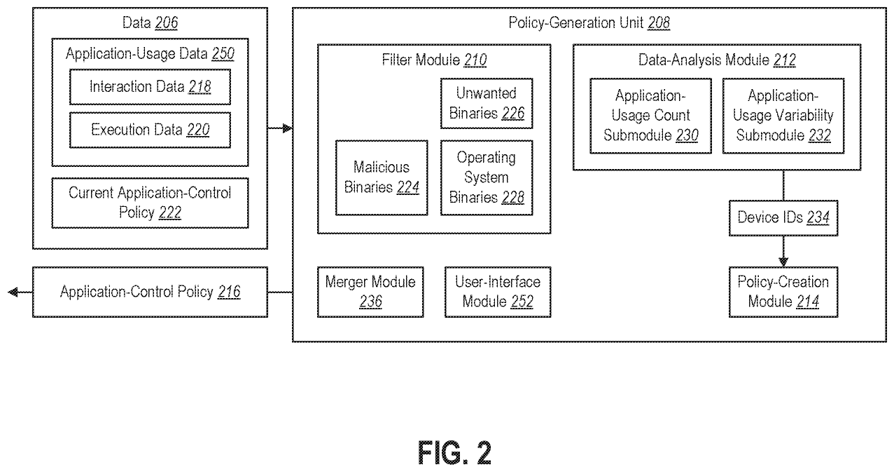

FIG. 2 illustrates a potential example of a policy-generation unit 208. The policy-generation unit 208 may be designed to receive data (which may include application-usage data for one or more devices associated with an enterprise), identify, based on application-usage data, a set of candidate devices from the one or more devices associated with the enterprise, and generate an application-control policy for the set of candidate devices based on application-usage data. The policy-generation unit 208 may identify more than one set of candidate devices and may generate an application-control policy for more than one set of candidate devices.

The policy-generation unit 208 may receive a variety of data 206. The data 206 may include application-usage data 250 and a current application-control policy 222.

Application-usage data 250 may include information regarding applications and binaries executed on one or more devices. Application-usage data 250 may include two types of application-usage data: interaction data 218 and execution data 220. Interaction data 218 may be application-usage data regarding execution of binaries a user of a device interacted with while using the device (interaction events). Execution data may be application-usage data regarding any execution of a binary on a device (execution events). Interaction events may be considered a sub-type of execution events.

In some designs, interaction data 218 may be a separate and distinct data stream from execution data 220. In those cases, it may be that execution data 220 includes all the information contained in the interaction data 218. In other designs, interaction data 218 and execution data 220 form a single data stream but the application-usage data 250 indicates directly or indirectly which execution events are interaction events. In those cases, it may be that interaction data 218 is a subset of execution data 220.

In some designs, the application-usage data 250 may be considered a log of execution events. Each log entry may include a variety of information regarding an execution event, including information identifying a name and file type of an executed binary, information identifying a device (such as a device ID) on which an execution event occurred, the date and time an execution event occurred, information regarding who was using a device at a time when an execution event occurred, information regarding a physical location of a device at a time an execution event occurred, information regarding a file path of the executed binary, information regarding any parent or child relationships of the executed binary, and information indicating what caused the binary to be executed (such as whether the execution resulted from a user interaction with a device).

In certain circumstances, it may be desirable to analyze only interaction data 218 instead of analyzing all execution data 220. For example, interaction data 218 may contain sufficient information to identify all applications a user interacted with while using a device. In trying to compare application usage of two devices during a specific time period, analyzing only interaction data 218 for the two devices may simplify the analysis because interaction data 218 may be a significantly smaller set of data than execution data 220 for the specific time period. Thus, relying only on interaction data (and thus only on interaction events) to identify sets of candidate devices may allow the policy-generation unit 208 to generate application-control policies more efficiently than would be possible if the policy-generation unit 208 relied on execution data 220 (and thus all execution events) to identify sets of candidate devices.

The current application-control policy 222 may include information regarding any application-control policies that are currently deployed on one or more devices. The current application-control policy 222 may be an application-control policy previously generated by the policy-generation unit 208. In other instances, it may also be an application-control policy generated by an enterprise. The current application-control policy 222 may have controlled what execution events are included in the application-usage data 250. For example, the application-usage data 250 may not include data regarding executions of binaries that are included in the current application-control policy 222.

The policy-generation unit 208 may use one or more modules to generate an application-control policy 216 for a set of candidate devices. The one or more modules may include a filter module 210, a data-analysis module 212, a policy-creation module 214, and a merger module 236.

The filter module 210 may be designed to reduce an amount of application-usage data used by the policy-generation unit 208 to identify one or more sets of candidate devices or to generate the application-control policy 216. One way the filter module 210 may reduce an amount of application-usage data used by the policy-generation unit 208 is to filter out application-usage events logged in application-usage data that meet (or do not meet) certain criteria. One reason the filter module 210 may filter out certain application-usage events is because those application-usage events may be unnecessary for or unhelpful to identifying sub-groups of devices or generating the application-control policy 216.

For example, in cases in which application-usage data includes interaction events and execution events, the filter module 210 may filter out execution events before the data-analysis module 212 attempts to identify one or more sub-groups of devices. It may be that application-usage data includes far more execution events than interaction events. And it may be that interaction events convey sufficient information about application usage for purposes of identifying sub-groups of devices. Thus, using only interaction events (as opposed to using all execution events) may simplify and streamline the analysis relevant to identifying sub-groups.

In another example, the filter module 210 may possess or receive a list of malicious binaries 224 and a list of unwanted binaries 226. The filter module 210 may filter out application-usage events in application-usage data associated with binaries contained in the list of malicious binaries 224 or the list of unwanted binaries 226. It may be beneficial to filter out such binaries because they do not help identify a set of candidate devices. It may also be beneficial to filter out such binaries because an enterprise does not want malicious and unwanted binaries included in an application-control whitelist.

In another example, the filter module 210 may possess a list of operating system binaries 228. The filter module 210 may filter out application-usage events in application-usage data related to executions of binaries contained on the list of operating system binaries 228. It may be beneficial to filter out binaries contained on the list of operating system binaries 228 because those binaries may not help identify a set of candidate devices and need to be included in an application-control policy regardless of whether they appear in the application-usage data 250.

In another example, the filter module 210 may filter application-usage data based on date or time constraints.

In another example, the filter module 210 may filter application-usage data by removing data associated with multiple executions of a binary. It may be beneficial to filter out multiple executions of a binary in creating the application-control policy 216 because it may be that a binary needs to be added to the application-control policy 216 only once.

In another example, the filter module 210 may filter application-usage data based on a device ID such that the application-usage data includes only application-usage events associated with one or more particular device IDs.

The data-analysis module 212 may be designed to use received application-usage data (which may have been filtered by the filter module 210) and identify one or more sets of candidate devices. The data-analysis module 212 may use various means and criteria to identify a set of candidate devices. The data-analysis module 212 may identify a set of candidate devices based at least in part on the application-usage data 250. The data-analysis module 212 may identify a set of candidate devices based at least in part on application-usage characteristics of one or more devices. The data-analysis module 212 may use the application-usage data 250 to determine application-usage characteristics of one or more devices. The data-analysis module 212 may identify a set of candidate devices based at least in part on device characteristics, user characteristics, or enterprise policies. A set of candidate devices may be a set of devices having certain similarities in application usage, application-usage characteristics, device characteristics, or user characteristics. A set of candidate devices may also be a set of devices where each device meets certain defined criteria. The defined criteria may relate to application usage, application-usage characteristics, device characteristics, or user characteristics. In identifying a set of candidate devices, the data-analysis module 212 may seek to identify one or more devices for which a single application-control policy may provide a desired level of security while limiting productivity interference to an acceptable level.

The data-analysis module 212 may use one or more submodules to identify a set of candidate devices. These submodules may include a distinct application usage submodule 230 and an application-usage variability submodule 232.

The distinct application usage submodule 230 may be designed to calculate a measure of distinct applications executed on a device during one or more time periods. This calculation may be based solely on how many distinct applications a device executed during a time period or may be relative to how many distinct applications other devices executed during the time period. This calculation may measure only distinct applications a user of a device interacted with during one or more time periods. Although the following discussion will focus on calculating measurements of distinct applications a user of a device interacted with, the calculation may also measure all distinct applications executed on a device, regardless of whether an execution resulted from user interaction.

The distinct application usage submodule 230 may calculate a measure of distinct applications executed on a device in various ways.

The distinct application usage submodule 230 may determine a raw number of distinct applications a user interacted with using a device during a particular time period (such as during part of a particular day, during a particular day, during two non-consecutive days, or during a week). This number may be considered an application-usage count.

As another example, the distinct application usage submodule 230 may determine a mean or median application-usage count for all devices in a set of devices and then determine how much greater or lesser the application-usage count is for each device in the set of devices.

As another example, the distinct application usage submodule 230 may also determine an average number of distinct applications a user of a device interacted with during each of two or more time periods (such as an average number per day for two consecutive or non-consecutive days).

As another example, the distinct application usage submodule 230 may determine an application-usage count for each device in a set of devices and then divide the set of devices into two or more groups (such as quartiles) based the application-usage count for each device.

As another example, the distinct application usage submodule 230 may use other statistical measures, such as standard deviation, to calculate a measure of distinct applications a user interacted with during one or more specific time periods.

The distinct application usage submodule 230 may, after calculating a measurement of distinct applications a user interacted with during one or more specific time periods, compare calculated measurements of devices within a set of devices. The distinct application usage submodule 230 may use this comparison to determine whether two or more devices may qualify for inclusion in a set of candidate devices. The distinct application usage submodule 230 may use predefined criteria in determining whether two or more devices may qualify for inclusion in a set of candidate devices.

The following are examples of how the distinct application usage submodule 230 may determine whether two or more devices may qualify for inclusion in a set of candidate devices. These examples make reference to application-usage counts but could similarly apply to other measures of distinct applications executed on a device during one or more time periods. The distinct application usage submodule 230 may be designed to determine that only devices with sufficiently similar application-usage counts may be considered for inclusion in a set of candidate devices. The distinct application usage submodule 230 may also be designed to determine that only devices with an application-usage count above or below a specific threshold number or only devices with an application-usage count falling within a specific range may be considered for inclusion in a set of candidate devices. The distinct application usage submodule 230 may also be designed to determine that devices with application-usage counts that are statistical outliers as compared to application-usage counts of other devices should not be considered for inclusion in a set of candidate devices. For example, devices with application-usage counts outside of <+−1.5*InterQuartile Range> may not be considered for inclusion in a set of candidate devices.

Calculating a measure of distinct applications a user interacted with during a particular period of time may help identify a set of candidate devices because it may be that a single application-control policy is more likely to be effective for a set of devices that have interacted with a similar number of applications during a particular time period. It may be that applying a single application-control policy to two devices where device A interacted with significantly more applications than device B during a particular time period may not achieve a desirable balance between security and productivity. An application-control policy that allows device A to execute binaries necessary for a first user of device A to perform the first user's work may allow device B to execute far more applications than necessary for a second user of device B to perform the second user's work. In that situation, the application-control policy may provide far less security with respect to device B than could be achieved with a policy more tailored to the usage of device B. On the other hand, an application-control policy limited to applications the second user of device B needs to use would provide greater security for device B but would excessively limit the first user of device A from performing the first user's work. For these reasons, it may be that device A and device B would not be candidates for being grouped together as a sub-group.

The application-usage-variability submodule 232 may be designed to calculate a measure of variability of application usage by a device across two or more time periods (application-usage variability). The application-usage-variability submodule 232 may use this calculation in identifying devices that may qualify for inclusion in a set of candidate devices. Another way to describe application-usage variability may be a measure of how consistently a user of a device interacts with the same applications across two or more time periods. Another way to describe application-usage variability may be a measure of how frequently a user of a device interacts with an application in less than all of two or more time periods. This calculation may be based solely on application usage of a particular device or may be relative to application usage of other devices. This calculation may be a measure of variability of application usage only for applications a user of a device interacted with.

The application-usage-variability submodule 232 may calculate a measure of distinct applications executed on a device in various ways. One way the application-usage-variability submodule 232 may calculate application-usage variability is with the following: <#Applications seen only in a specific time window>/<#Applications consistent across all time windows>. With respect to this example measurement method, it may be desirable for application-usage variability to be as low as possible. It may be that devices that utilize new applications all the time and that do not maintain a logical device profile are not a good fit for application control.

The application-usage-variability submodule 232 may, after calculating application-usage variability for each device of a set of devices, compare application-usage variability of devices within the set of devices. The application-usage-variability submodule 232 may use this comparison to determine whether two or more devices may qualify for inclusion in a set of candidate devices. The application-usage-variability submodule 232 may use predefined criteria in determining whether two or more devices may qualify for inclusion in a set of candidate devices.

The application-usage-variability submodule 232 may be designed to determine that only devices with a sufficiently low level of application-usage variability may be considered for inclusion in a set of candidate devices. The application-usage-variability submodule 232 may also be designed to determine that only devices with a measure of application-usage variability above or below a specific threshold number or only devices with a measure of application-usage variability falling within a specific range may be considered for inclusion in a set of candidate devices. The application-usage-variability submodule 232 may also be designed to determine that a device with a measure of application-usage variability that is a statistical outlier as compared to measures of application-usage variability of other devices should not be considered for inclusion in a set of candidate devices.

Calculating application-usage variability may help identify a set of candidate devices because it may be that an application-control policy would excessively restrict productivity of a device that constantly needs to use new applications to perform necessary business tasks.

The data-analysis module 212 may be designed to identify as a set of candidate devices any devices that both the application-usage-count submodule 230 and the application-usage-variability submodule 232 determine may qualify for inclusion in the set of candidate devices. The data-analysis module 212 may run the application-usage-count submodule 230 and the application-usage-variability submodule 232 serially. In that case, the data-analysis module 212 may use the application-usage-count submodule 230 to identify a first set of devices that may qualify for inclusion in a set of candidate devices and then use the application-usage-variability submodule 232 to analyze the first set of devices and determine which of those devices may still qualify for inclusion in the set of candidate devices. In other designs, the application-usage-count submodule 230 and the application-usage-variability submodule 232 may analyze application-usage data for a same set of devices.

The data-analysis module 212 may perform other calculations, measurements, or information not described above in identifying a set of devices. The application-usage-count submodule 230 and the application-usage-variability submodule 232 are provided only as examples of calculations, measurements, and information the data-analysis module 212 may perform or use in identifying a set of candidate devices. For example, the data-analysis module 212 may consider how many unwanted or malicious binaries a device executed in a particular time period. It may be that devise that execute a large number of unwanted or malicious binaries (either in absolute terms or relative to other devices) are sources of risk to an enterprise and the enterprise would benefit from applying application control to those devices. By way of another example, the data-analysis module 212 may consider a type of user associated with a device in identifying a set of candidate devices. It may be that devices with similar user types (such as employees of an enterprise with similar roles or jobs) may be candidates for inclusion in a set of candidate devices.

After identifying a set of candidate devices, the data-analysis module 212 may provide information regarding the set of candidate devices to the policy-creation module 214. The data-analysis module 212 may provide information sufficient to identify each device in a set of candidate devices. For example, the data-analysis module 212 may provide a list of device IDs 234 to the policy-creation module 214.

The policy-creation module 214 may be designed generate an application-control policy for a set of candidate devices. An application-control policy may include a list of binaries that devices in a set of candidate devices is allowed to run. An application-control policy may include a list of known bad binaries and a list of unwanted binaries. An application-control policy may log or facilitate the logging of each attempt a device makes to execute a binary that is not listed as allowable in the application-control policy. An application-control policy may be designed to allow a managed installer to allow installation and execution of binaries not listed in the application-control policy.

The policy-creation module 214 may generate an application-control policy for a set of candidate devices based at least in part on application-usage data associated with the set of candidate devices. For example, the policy-creation module 214 may generate an application-control policy that allows every binary executed by a set of candidate devices. The policy-creation module 214 may, however, generate an application-control policy that does not allow binaries included in the list of malicious binaries 224 or the list of unwanted binaries 226 to run on the set of candidate devices, even if application-usage data indicates that the set of candidate devices executed those binaries. The policy-creation module 214 may also not allow binaries obtained from a particular source, such as a particular website.

The policy-creation module 214 may use application-usage data not identical to application-usage data used by the data-analysis module 212. The policy-creation module 214 may use application-usage data that includes execution data while the data-analysis module 212 may use only interaction data. The policy-creation module 214 may use application-usage data generated for a second time period while the data-analysis module 212 may use application-usage data generated for a first time period not identical to the second time period. For example, it may be that the data-analysis module 212 identifies a set of candidate devices based on interaction data generated during a first time period, the policy-generation unit 208 receives application-usage data for the set of candidate devices for a second time period after the first time period, and the policy-creation module 214 generates an application-control policy for the set of candidate devices based on application-usage data for the second time period.

The policy-generation unit 208 may be designed to take an application-control policy generated by the policy-creation module 214 and output it as the application-control policy 216. In other designs, the policy-generation unit 208 may be designed to use a merger module 236 to generate the application-control policy 216. The merger module 236 may be designed to use the current application-control policy 222 and an application-control policy generated by the policy-creation module 214 to generate the application-control policy 216. The merger module 236 may include in the application-control policy 216 all binaries listed in the current application-control policy 222 and in an application-control policy generated by the policy-creation module 214.

The application-control policy 216 may be designed to operate in different modes. The application-control policy 216 may have an audit mode. When operated in audit mode, the application-control policy 216 may log or cause a device to log all attempts to execute a binary that is not listed as allowable but still allow execution of the binary. The application-control policy 216 may have an enforcement mode. When operated in enforcement mode, the application-control policy 216 may log or cause a device to log all attempts to execute a binary that is not listed as allowable and prohibit execution of the binary.

The policy-generation unit 208 may be designed to deploy the application-control policy 216 to a set of candidate devices. The policy-generation unit 208 may deploy the application-control policy 216 directly to a set of candidate devices or may send an application-control policy to an enterprise. The policy-generation unit 208 may send the application-control policy 216 as a recommendation that an enterprise may accept, reject, or modify.

The policy-generation unit 208 may include a user-interface module 252. The user-interface module 252 may be designed to receive inputs. Inputs may define criteria used to identify a set of candidate devices or to generate an application-control policy. The user-interface module 252 may also be designed to allow a user to view and manipulate data 206 received by the policy-generation unit 208. It may also be designed to allow a user to control the policy-generation unit 208, including the filter module 210, the data-analysis module 212, the policy-creation module 214, and the merger module 236. The user-interface module 252 may allow a user to view and manipulate filtering performed by the filter module 210, calculations performed by the data-analysis module, and application-control policies generated by the policy-creation module 214.

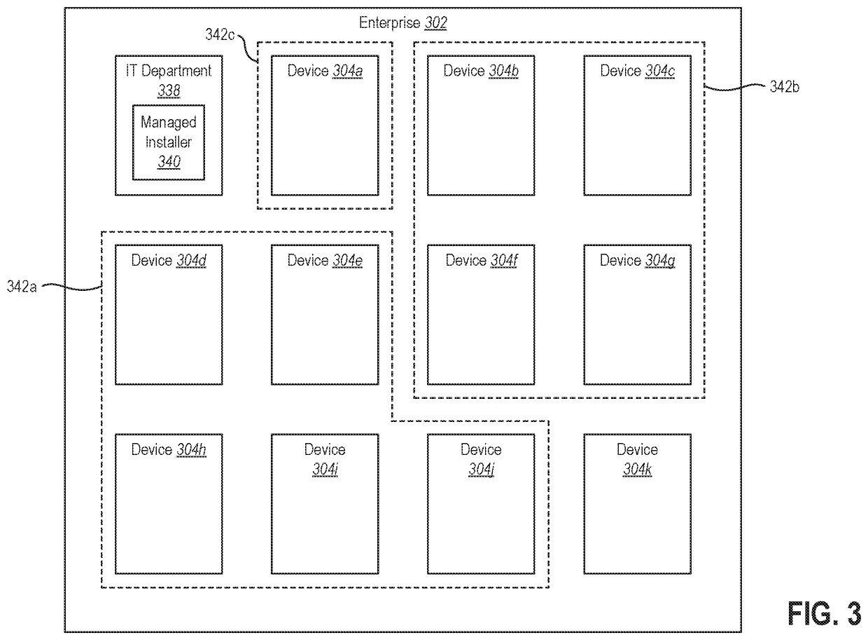

FIG. 3 illustrates one potential example of an enterprise 302.

The enterprise 302 may be an individual or organization that uses at least one computing device. For example, the enterprise 302 may be a large or small business, a government agency, or a non-profit organization. The enterprise 302 may exist at a single location, multiple locations, or may not be associated with any particular location. The enterprise 302 may be a virtual entity.

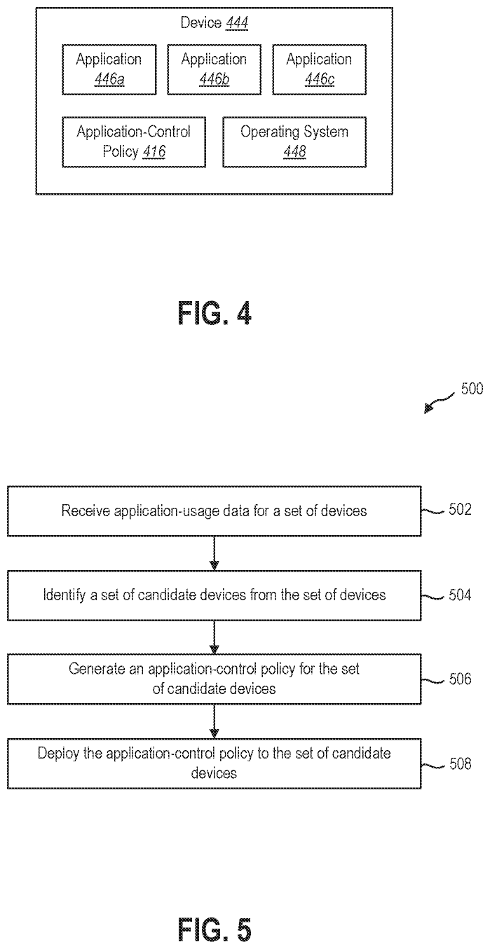

The enterprise 302 may include a set of devices 304. The set of devices may be used to perform tasks for the enterprise 302, allow the enterprise 302 to provide services to third parties, or be used by third parties visiting the enterprise 302. In FIG. 4, the set of devices 304 includes 11 devices. In other examples, a set of devices may include thousands of devices.

The enterprise 302 may have the right and ability to control use of the set of devices 304. For example, the enterprise 302 may have the right and ability to control what applications run on the set of devices 304. The enterprise 302 may utilize third-party software or service providers to control use of the set of devices 304.

Each device in the set of devices 304 may have one or more associated users. In other situations, a device may not be associated with any particular user. Each device in the set of devices 304 may have security controls limiting who can use the device. For example, a device 304a may require a user to enter a password before the user can access the device 304a.

Each device in the set of devices 304 may have a unique device identifier.

Each device in the set of devices 304 may be associated with a particular user type. For example, device 304b may be associated with a manager level employee, device 304k may be associated with a vice-president level employee, and device 304a may be associated with a receptionist-type employee.

The set of devices 304 may produce application-usage data. The application usage data may include information regarding applications and binaries executed on the set of devices 304.

The set of devices 304 may include one or more candidate groups 342. For example, the set of devices 304 may include candidate group 342a (consisting of device 304d, device 304e, device 304h, and device 304i), candidate group 342b (consisting of device 304b, device 304c, device 304f, and device 304g), and candidate group 342c (consisting of device 304a). Although not shown in FIG. 3, each device that is part of one of the candidate groups 342 may include an application-control policy applicable to all devices in that particular candidate group.

It may be that not all devices in the set of devices 304 are included in one of the candidate groups 342. For example, it may be that device 304k is not included in one of the candidate groups 342.

The enterprise 302 may include an IT department 338. The IT department 338 may manage the set of devices 304. The IT department 338 may have access to information associated with the set of devices 304, including application-usage data created by the set of devices 304. The IT department 338 may facilitate the creation and updating of application-control policies. The IT department 338 may have access to a policy-generation unit. The IT department 338 may use a policy-generation unit to create and update application control policies.

The IT department 338 may include a managed installer 340. The managed installer 340 may allow the IT department 338 to install applications on the set of devices 304 that are not included in an applicable application-control policy.

FIG. 4 illustrates one potential example of a device 444 that may be part of an enterprise. The device 444 may be any type of computing device. The device 444 may be any type of device capable of responding to user interaction and executing applications and binary files. Such devices may include cell phones, laptops, desktop computers, tablets, barcode scanners, video game consoles, streaming devices, and wearable devices.

The device 444 may include applications 446a, 446b, 446c. The device 444 may have obtained the applications 446a, 446b, 446c using different means. The device 444 may have downloaded application 446a from the internet. Application 446b may have been installed on the device 444 from a portable memory device, such as a USB drive or a CD-ROM. Application 446c may have been installed on the device 444 through a managed installer operating on a local network.

The device 444 may include an operating system 448. The operating system 448 may include binaries necessary for the device 444 to operate.

The device 444 may include an application-control policy 416. The application-control policy 416 may control whether the device 444 can install or execute a particular binary.

The device 444 may produce application-usage data. The application usage data may include information regarding applications and binaries executed on the device 444. The device 444 may use a third-party software application or service provider to create, manage, store, or share application usage data. The application-control policy 416 may determine what application-usage events the device 444 reports.

The device 444 may store its application-usage data locally. The device 444 may later send a copy of its application-usage data to another location. In other designs, the device 444 may temporarily store its application-usage data locally for some period of time and then transmit it to an external location. In other designs, the device 444 may immediately transmit its application-usage data to a remote location as the device 444 creates the application usage data.

FIG. 5 illustrates one potential method 500 for generating an application-control policy.

The method 500 may include receiving 502 application-usage data from a set of devices. The set of devices may be associated with an enterprise. The application-usage data may include information regarding binaries and applications executed on the set of devices.

The method 500 may include identifying 504 a set of candidate devices from the set of devices. Identifying 504 the set of candidate devices from the set of devices may include filtering the application-usage data, calculating a measurement of distinct applications executed or interacted with on one or more devices in the set of devices during a particular time period, and calculating a measurement of application-usage variability for one or more devices in the set of devices across two or more time periods.

The method may include generating 506 an application-control policy for the set of candidate devices. The application-control policy for the set of candidate devices may be based on binaries executed on the set of candidate devices. Generating 506 the application-control policy may include excluding known bad and unwanted binaries from the application-control policy.

The method may include deploying 508 the application-control policy to the set of candidate devices.

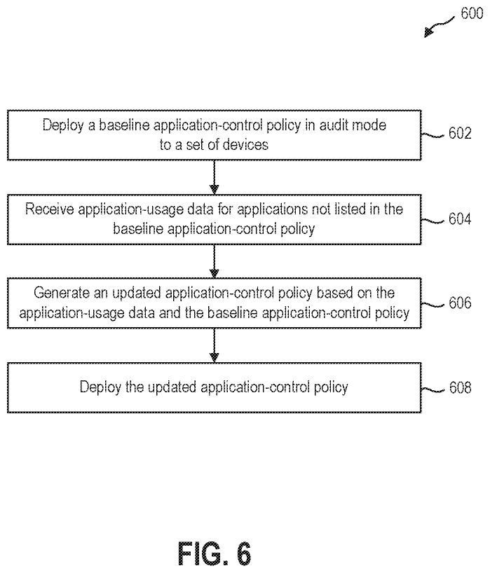

FIG. 6 illustrates one potential method 600 for revising an application-control policy.

The method 600 may include deploying 602 a baseline application-control policy in audit mode to a set of devices. The baseline application-control policy may not include any binaries on a whitelist. In that case, the baseline application-control policy may cause the set of devices to log all binary executions. In other designs, the baseline application-control policy may include operating system binaries. In other designs, the baseline application-control policy may be an application-control policy that a policy-generation unit generated in accordance with the present disclosure, such as through the use of the method 500.

The method 600 may include receiving 604 application-usage data for applications not listed in the baseline application-control policy.

The method 600 may include generating 606 an updated application-control policy based on the application-usage data and the baseline application-control policy. Generating 606 the updated application-control policy may include excluding from the updated application-control policy known bad and unwanted binaries.

The method 600 may include deploying 608 the updated application-control policy to the set of devices.

Provided below are two example scenarios in which the systems and methods described may be used.

In a first scenario, an IT professional at a large home improvement retail company may want to secure enterprise devices with an application-control policy. For purposes of this illustration, the large home improvement retail company may have approximately 355,000 employees and include hundreds of different groups and teams running thousands of different applications every day. The IT professional may be the only employee on his IT solutions team familiar with application-control and may fear that the task of properly screening applications to create or maintain an application-control policy may be too time-consuming and that taking responsibility for the task may expose the company to security threats.

Using the systems and methods described in the present disclosure, the IT professional may be able to receive application telemetry from devices across the entire enterprise. The IT professional may be able to identify and group devices by employee type and then monitor application and binary execution per team. The IT professional may be able to use the systems and methods described to analyze the device telemetry for applications that should be included in an application whitelist. The IT professional may use the systems and methods of the present disclosure to obtain an auto-generated application-control policy recommendation.

The IT professional would then have access to a baseline application-control policy recommendation for each set of candidate devices. The IT professional may vet the recommendation for inappropriate or malicious binary downloads. The IT professional and his team may now deploy the baseline application-control policy to audit for reporting purposes or enforce the baseline application-control policy to secure the company's devices. Applications not accounted for in the baseline application-control policy may be individually identified and if needed, merged into the baseline application-control policy. In addition to making individual merges for a new application's executables, the IT professional can use a managed installer to install applications that the IT professional has approved post-policy generation. As long as the managed installer is whitelisted by the enterprise, applications installed will be signed as children of that managed installer and therefore have unblocked access to run on any relevant device. Intermediately, the IT professional may rerun the disclosed systems and methods to create new baseline application-control policies for the enterprise. Doing so may allow the IT professional to incorporate any new applications not originally incorporated into an application-control policy into a revised application-control policy that allows the new applications to run on relevant devices.

In a second scenario, Jan Smith recently adopted a system in accordance with the present disclosure to ease the management of a petroleum company's application whitelisting. Jan successfully used the systems and methods of the present disclosure on the petroleum company's device telemetry and created a baseline application-control policy that her IT solutions team could use to vet for applications relevant to the company's business requirements. In each policy Jan specified that a managed installer would be allowed to run on enterprise devices and since the initial recommendation, Jan has been using the managed installer to deploy new applications that she deems pertinent to the company's needs. After a brief analysis of recent downloads made through the managed installer by the IT team, she has identified a set of new applications that are common across one sub-group but not a part of its baseline application-control policy. Jan also believes, based off the analysis, that there may have been a few applications installed by the managed installer that have the potential to compromise the company's devices. She decides to use the systems and methods of the present disclosure to create a new application-control policy recommendation that will include the new set of applications but also mitigate the managed installer's security risk.

After rerunning the systems and methods described over the company's enterprise devices, Jan finds she has a new application-control policy that better represents the sub-group's application requirements. The new recommendation also excluded many of the applications deemed unsecure by Jan's previous analysis. She can now run the policy in audit mode to verify the correctness of the recommendation and eventually enforce it on newly on-boarded devices. This new recommendation can be built upon and used in conjunction with the managed installer to continue to authorize new applications. Finally, Jan believes there is opportunity to set up a recurring process that would use the systems and methods of the present disclosure to regenerate the company's application-control policies whenever an application set is identified whose usage is both common across the organization and pertinent to the company's workflow. She creates an outline for the process and meets with her colleagues to inform them of this new security procedure.

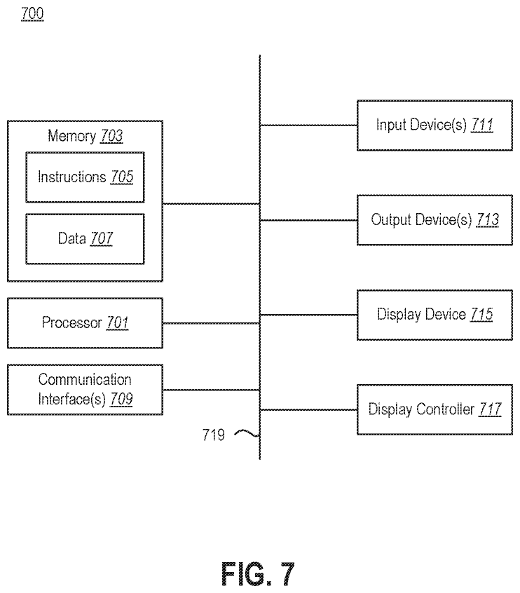

FIG. 7 illustrates certain components that may be included within a computer system 700. One or more computer systems 700 may be used to implement the techniques, systems, and methods disclosed herein. The various computing devices, modules, units, and systems described above may be implemented with some or all of the components shown in the computer system 700.

The computer system 700 includes a processor 701. The processor 701 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof

Instructions 705 and data 707 may be stored in the memory 703. The instructions 705 may be executable by the processor 701 to implement some or all of the methods disclosed herein. Executing the instructions 705 may involve the use of the data 707 that is stored in the memory 703. When the processor 701 executes the instructions 705, various portions of the instructions 705a may be loaded onto the processor 701, and various pieces of data 707a may be loaded onto the processor 701.

Any of the various examples of modules and components described herein may be implemented, partially or wholly, as instructions 705 stored in memory 703 and executed by the processor 701. Any of the various examples of data, values, or information described herein may be among the data 707 that is stored in memory 703 and used during execution of the instructions 705 by the processor 701.

A computer system 700 may also include one or more communication interfaces 709 for communicating with other electronic devices. The communication interfaces 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker, printer, etc. One specific type of output device that is typically included in a computer system is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A system for generating an application-control policy for deployment on one or more devices, comprising:
one or more processors; and
memory comprising instructions that are executable by the one or more processors to perform operations comprising:
receiving a first set of application-usage data for a set of devices;
determining one or more application-usage characteristics for one or more devices in the set of devices based at least in part on the first set of application-usage data;
identifying a set of candidate devices from the set of devices based at least in part on the one or more application-usage characteristics;
generating the application-control policy for the set of candidate devices based on a second set of application-usage data for the set of candidate devices; and
providing the application-control policy for deployment on the set of candidate devices.

2. The system of claim 1, wherein the first set of application-usage data identifies binaries with which users of the set of devices interacted.

3. The system of claim 2, wherein determining the one or more application-usage characteristics for the one or more devices in the set of devices is done based on data associated with the binaries with which users of the one or more devices interacted.

4. The system of claim 1, wherein the one or more application-usage characteristics include a measure of distinct applications used during a specified time period.

5. The system of claim 4, wherein identifying the set of candidate devices includes determining that a device from the set of devices whose measure of distinct applications used during the specified time period does not meet a defined criteria is not part of the set of candidate devices.

6. The system of claim 4, wherein the measure of distinct applications used during the specified time period is a number of distinct applications used during the specified time period.

7. The system of claim 1, wherein the one or more application-usage characteristics include a measure of variability of application usage across a set of specified time periods.

8. The system of claim 7, wherein identifying the set of candidate devices includes determining that a device from the set of devices whose measure of variability of application usage across the set of specified time periods does not meet a defined criteria is not part of the set of candidate devices.

9. The system of claim 7, wherein the measure of variability of application usage is determined by dividing a first number of applications used only during a first specified time period by a second number of applications used across each time period of the set of specified time periods, the first specified time period being in the set of specified time periods.

10. The system of claim 1, wherein the second set of application-usage data for the set of candidate devices covers a time period not identical to the first set of application-usage data for the set of devices.

11. The system of claim 1, wherein the memory further comprises instructions that are executable by the one or more processors to perform operations comprising:
deploying the application-control policy to the set of candidate devices.

12. A computer-implemented method, comprising:
receiving a first set of application-usage data for a set of devices;
determining one or more application-usage characteristics for one or more devices in the set of devices based at least in part on the first set of application-usage data;
identifying a set of candidate devices from the set of devices based at least in part on the one or more application-usage characteristics;
generating an application-control policy for the set of candidate devices based on a second set of application-usage data for the set of candidate devices; and
providing the application-control policy for deployment on the set of candidate devices.

13. The computer-implemented method of claim 12, wherein the first set of application-usage data includes interaction data.

14. The computer-implemented method of claim 13, wherein determining the one or more application-usage characteristics for the one or more devices in the set of devices is done based on interaction data.

15. The computer-implemented method of claim 12, wherein the one or more application-usage characteristics include a measure of distinct applications used during a specified time period.

16. The computer-implemented method of claim 15, wherein identifying the set of candidate devices includes determining that a device from the set of devices whose measure of distinct applications used during the specified time period does not meet a defined criteria is not part of the set of candidate devices.

17. The computer-implemented method of claim 12, wherein the one or more application-usage characteristics include a measure of variability of application usage across a set of specified time periods.

18. The computer-implemented method of claim 17, wherein identifying the set of candidate devices includes determining that a device from the set of devices whose measure of variability of application usage across the set of specified time periods does not meet a defined criteria is not part of the set of candidate devices.

19. A computer-readable medium having computer-executable instructions stored thereon that, when executed, cause one or more processors to perform operations comprising:
receiving a first set of application-usage data for a set of devices;
determining one or more application-usage characteristics for one or more devices in the set of devices based at least in part on the first set of application-usage data, wherein the one or more application-usage characteristics include:
a measure of distinct applications used during a specified time period; and
a measure of variability of application usage across a set of specified time periods;
identifying a set of candidate devices from the set of devices based at least in part on the one or more application-usage characteristics, wherein identifying the set of candidate devices includes one or more of:
determining that a first device from the set of devices whose measure of distinct applications used during the specified time period does not meet a first criteria is not part of the set of candidate devices; and
determining that a second device from the set of devices whose measure of variability of application usage across the set of specified time periods does not meet a second criteria is not part of the set of candidate devices;
generating an application-control policy for the set of candidate devices based on a second set of application-usage data for the set of candidate devices; and
providing the application-control policy for deployment on the set of candidate devices.

20. The computer-readable medium of claim 19, wherein the first set of application-usage data identifies binaries with which users of the set of devices interacted and determining the one or more application-usage characteristics for the one or more devices in the set of devices is done based on data associated with the binaries with which users of the one or more devices interacted.
